(19) United States
(12) Patent Application Publication
(10) Pub. No.: US 2011/0081030 A1
(43) Pub. Date: Apr. 7, 2011

(54) PERSONAL TRANSMITTER FOR A MICROPHONE

(76) Inventor: Kun-Tien Chiang, Tainan County (TW)

(21) Appl. No.: 12/777,685

(22) Filed: May 11, 2010

(30) Foreign Application Priority Data
Oct. 2, 2009 (TW) 098218242

(51) Int. Cl. H04R 3/00

(52) U.S. Cl. 381/122

(57) ABSTRACT

A personal transmitter for receiving and wirelessly transmitting an audio signal of a microphone includes a case, and a limiting unit disposed in the case. The limiting unit includes a primary circuit for receiving the audio signal of the microphone and adjusting an amplitude of the audio signal. The primary circuit has a variable resistance unit and a forward amplifier coupled together. The limiting unit includes a feedback circuit coupled to the primary circuit for receiving an output of the primary circuit and for feedback control that reduces a gain of the primary circuit when the amplitude of the audio signal exceeds a predetermined input threshold value.

The personal transmitter also includes an amplifying unit disposed in the case and coupled to the limiting unit for receiving and amplifying an output of the limiting unit. The personal transmitter further includes a transmitter unit disposed in the case and coupled to the amplifying unit for receiving and wirelessly transmitting an output of the amplifying unit.

### CROSS-REFERENCE TO RELATED APPLICATION

This application claims priority to Taiwanese Application No. 98218242, filed on Oct. 2, 2009, the disclosure of which is incorporated herein by reference.

### BACKGROUND OF THE INVENTION

1. Field of the Invention

The invention relates to a personal transmitter for a microphone, more particularly to a personal transmitter for receiving and wirelessly transmitting an audio signal.

2. Description of the Related Art

A personal transmitter may amplify and transmit an audio signal received from a microphone to a receiving device that outputs the audio signal using a speaker. The output of the speaker may be received from the microphone and amplified again, which may result in sharp howling noises, echoes, or other undesirable sounds.

### SUMMARY OF THE INVENTION

An object of the present invention is to provide a personal transmitter for a microphone that can ameliorate generation of undesirable sounds caused by recurring amplification.

Accordingly, a personal transmitter of this invention for receiving and wirelessly transmitting an audio signal of a microphone includes a case, and a limiting unit disposed in the case. The limiting unit includes a primary circuit for receiving the audio signal of the microphone and adjusting an amplitude of the audio signal. The primary circuit has a variable resistance unit and a forward amplifier coupled together. The limiting unit also includes a feedback circuit coupled to the primary circuit for receiving an output of the primary circuit and for feedback control that reduces a gain of the primary circuit when the amplitude of the audio signal exceeds a predetermined input threshold value.

The personal transmitter also includes an amplifying unit disposed in the case and coupled to the limiting unit for receiving and amplifying an output of the limiting unit. The personal transmitter further includes a transmitter unit disposed in the case and coupled to the amplifying unit for receiving and wirelessly transmitting an output of the amplifying unit.

A personal transmitter of this invention may include multiple advantages. For example, when the amplitude of the audio signal exceeds a predetermined input threshold value, a gain of the primary circuit is reduced to limit generation of undesirable sounds from a speaker caused by recurring input of an audio signal with an excessive amplitude to the amplifying unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a personal transmitter and associated devices, according to a preferred embodiment of the present invention;

FIG. 2 is another perspective view of the preferred embodiment;

FIG. 3 is a schematic circuit diagram of the preferred embodiment; and

FIG. 4 is a schematic circuit diagram of a restriction unit of the preferred embodiment.

### DETAILED DESCRIPTION OF THE PREFERRED EMBODIMENT

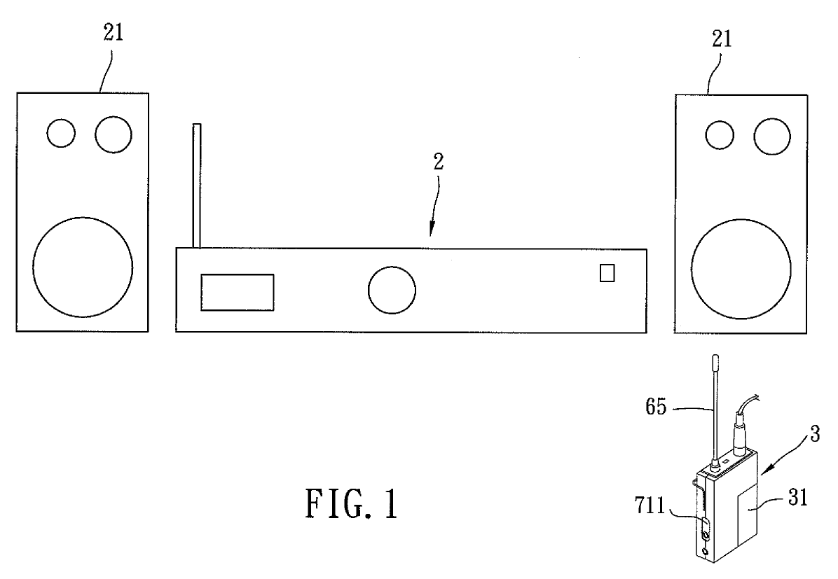

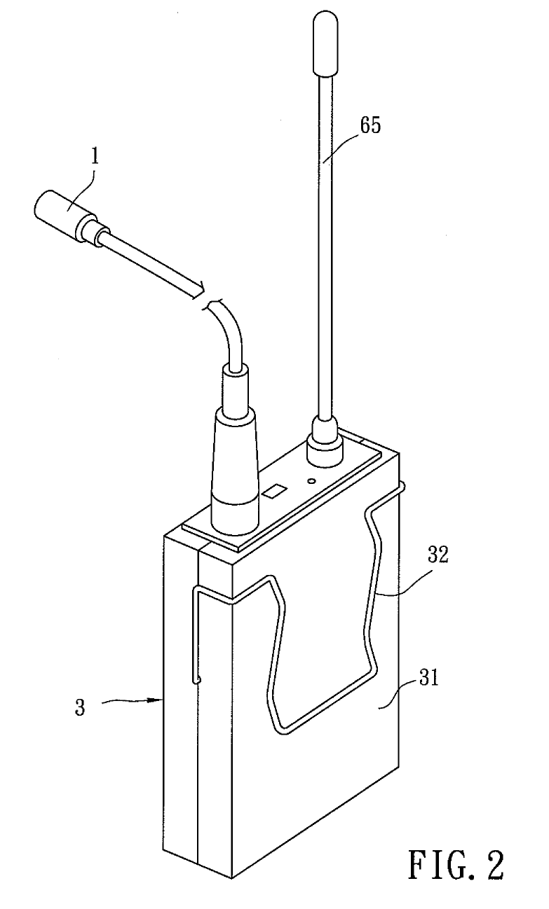

Referring to FIGS. 1 to 3, the preferred embodiment of a personal transmitter according to the present invention is shown to be adapted for receiving an audio signal from a microphone 1 for transmission to a signal receiving device 2 to be output from a pair of speakers 21. The personal transmitter includes a case 3, and further includes a limiting unit 4, an amplifying unit 5, a transmitter unit 6, and a frequency switching unit 7 each disposed in the case 3. In some embodiments, the microphone 1 is apart of the personal transmitter. The amplifying unit 5 is coupled to the limiting unit 4 for receiving and amplifying an output of the limiting unit 4. The transmitter unit 6 is coupled to the amplifying unit 5 for receiving and wirelessly transmitting an output of the amplifying unit 5.

The case 3 may include a housing 31 and a clip 32 disposed on a lateral side of the housing 31. The microphone 1 is coupled to the limiting unit 4. In variations of the preferred embodiment, the microphone 1 may communicate an audio signal to the personal transmitter wirelessly rather than through a coupled connection.

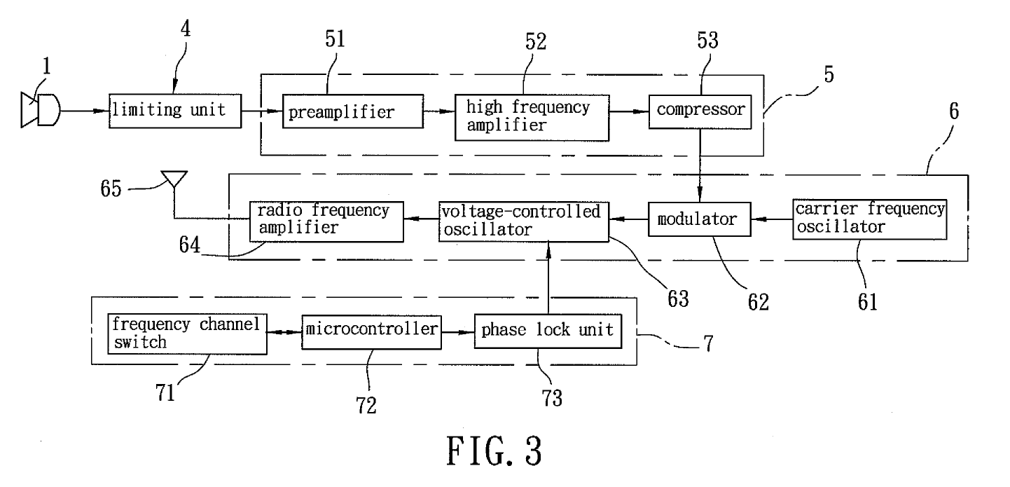

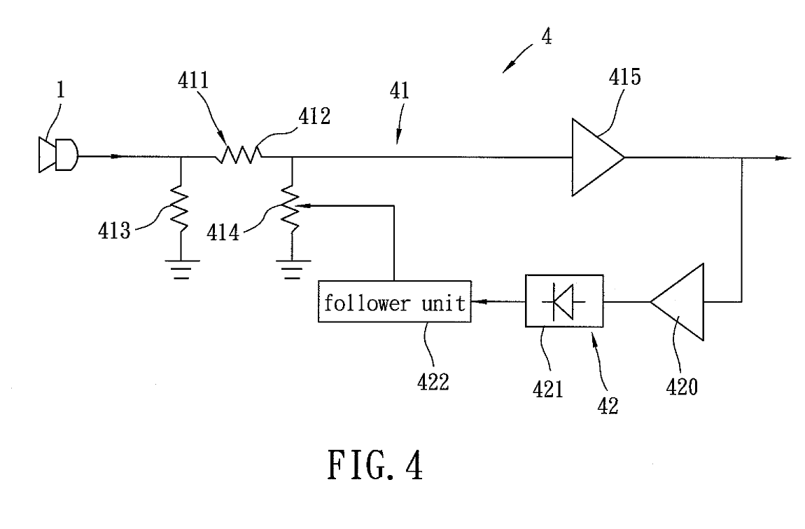

Referring to FIG. 4, the limiting unit 4 includes a primary circuit 41 for receiving and amplifying an audio signal from the microphone 1 for subsequent output to the amplifying unit 5 (shown in FIG. 3), and a feedback circuit 42 for receiving the output from the primary circuit 41 and performing feedback control of amplification gain of the primary circuit 41. The feedback circuit 42 reduces the amplification gain when the amplitude of the audio signal exceeds a predetermined input threshold value.

The primary circuit 41 has a variable resistance unit 411 and a forward amplifier 415 coupled in series. The variable resistance unit 411 includes a first resistor 412 coupled to the forward amplifier 415, a second resistor 414 with variable resistance coupled electrically between a rear end of the first resistor 412 and the ground, and a third resistor 413 coupled electrically between a front end of the first resistor 412 and the ground. The resistance of the second resistor 414 of the variable resistance unit 411 may be adjusted to modify the gain of the output from the primary circuit 41.

The feedback circuit 42 has a feedback amplifier 420, a rectification filter 421 and a follower unit 422 coupled in series. The output of the follower unit 422 is a control voltage that governs the resistance of the second resistor 414 of the variable resistance unit 411. When the direct current voltage from the rectification filter 421 is below a predetermined direct current (DC) voltage threshold value, the control voltage of the follower unit 422 is maintained at a constant value (such as 0 volts). When the direct current voltage from the rectification filter 421 exceeds the predetermined DC voltage threshold value, the control voltage of the follower unit 422 begins changing to follow the output voltage of the rectification filter 421.

In the preferred embodiment, the control voltage of the follower unit 422 increases or decreases when the direct current voltage from the rectification filter 421 increases or decreases, respectively, and is above the DC voltage threshold. In variations of the preferred embodiment, the control voltage of the follower unit 422 may be configured to decrease or increase when the direct current voltage from the rectification filter 421 increases or decreases, respectively, and is above the DC voltage threshold.

When the primary circuit 41 receives the audio signal from the microphone 1, the feedback amplifier 420 of the feedback circuit 42 receives and amplifies the audio signal output from the primary circuit 41. The output of the feedback amplifier 420 is received by the rectification filter 421, which outputs a direct current voltage that is received by the follower unit 422. The output of the follower unit 422 is a control voltage received by the variable resistance unit 411 to control a gain of the primary circuit 41.

The first resistor 412 and the second resistor 414 may be connected in series in a voltage divider configuration having an input voltage and an output voltage. The input voltage of the voltage divider is the audio signal received from the microphone 1, and the output voltage of the voltage divider is the voltage drop across the second resistor 414. The output voltage of the voltage divider may be supplied to the forward amplifier 415.

In the preferred embodiment, when the output of the follower unit 422 is constant, the resistance of the second resistor 414 of the variable resistance unit 411 is held constant to maintain a constant gain of the primary circuit 41. When the output of the follower unit 422 is varied, the resistance of the second resistor 414 of the variable resistance unit 411 is also varied.

The resistance of the second resistor 414 is reduced or increased to respectively decrease or increase the gain of the primary circuit 41. In variations of the preferred embodiment, the variable resistance unit 411 may be configured to decrease or increase a gain of the primary circuit 41 by respectively increasing or decreasing a resistance of a part of the variable resistance unit 911.

When the amplitude of the audio signal received by the primary circuit 41 is below an input threshold value, the direct current voltage from the rectification filter 421 is likewise below a DC voltage threshold value. When the direct current input of the follower unit 422 is below the DC voltage threshold value, the follower unit 422 maintains a constant output voltage that enables the primary circuit 41 to maintain a constant gain. The constant gain may be maintained by holding the resistance of the second resistor 414 of the variable resistance unit 411 at its current resistance value.

When the amplitude of the audio signal received by the primary circuit 41 exceeds the input threshold value, this indicates the volume of the input audio signal is too large. When the input threshold value is exceeded, the direct current voltage output from the rectification filter 421 also exceeds the DC voltage threshold, enabling the output voltage of the follower unit 422 to vary and follow the output of the rectification filter 421. The varying output of the follower unit 422 modulates the resistance of the variable resistance unit 411 to reduce the gain of the primary circuit 41 and to decrease the amplitude of the audio signal. This prevents audio signals with excessive amplitude from being received by the amplifying unit 5 (shown in FIG. 3).

Referring to FIG. 3, the amplifying unit 5 includes a preamplifier 51, a high frequency amplifier 52 and a compressor 53. The preamplifier 51 is coupled electrically to the limiting unit 4. Since the voltage output from the microphone 1 is relatively low, the preamplifier 51 is used to amplify the low-input audio signal of the microphone 1 transmitted from the limiting unit 4, providing a stable gain for small signals. The high frequency amplifier 52 is coupled electrically to the preamplifier 51 for amplifying high-frequency signals output from the preamplifier 51 to reduce quantization distortion. The compressor 53 is coupled electrically to the high frequency amplifier 52 to compress and restrict the amplitudes of output signals without substantial distortion.

The transmitter unit 6 includes a carrier frequency oscillator 61 for generating a carrier wave, and a modulator 62 for receiving and incorporating the audio signal from the amplifying unit 5 into the carrier wave. The transmitter unit 6 further includes a voltage-controlled oscillator 63 for receiving and modulating the signal output from the modulator 62, and a radio frequency amplifier 64 for amplifying the signal output from the voltage-controlled oscillator 63. The transmitter unit 6 also includes an antenna 65 disposed outwardly of the case 3 for wirelessly transmitting the signal output from the radio frequency amplifier 64. The transmitter unit 6 receives the output of the amplifying unit 5, and after modulation, wirelessly transmits the audio signal to the signal receiving device 2.

The voltage-controlled oscillator 63 is coupled electrically to the modulator 62, and its oscillation frequencies are determined using an input control voltage. The output of the modulator 62 is received as an input by the voltage-controlled oscillator 63, which generates a different modulated signal. The radio frequency amplifier 64 is coupled to the voltage-controlled oscillator 63. The antenna 65 is coupled to the radio frequency amplifier 64.

The frequency switching unit 7 has a frequency channel switch 71 with an operable part 711 disposed on the outer surface of the housing 31 to enable manipulation by a user. The frequency switching unit 7 further has a microcontroller 72 that is electrically coupled to the frequency channel switch 71 to receive frequency selection control signals from the frequency channel switch 71 or to identify an operating state of the frequency channel switch 71. The frequency switching unit 7 further includes a phase lock unit 73 that is electrically coupled to the voltage-controlled oscillator 63. The phase lock unit 73 is controlled by the microcontroller 72 for outputting a voltage to the voltage-controlled oscillator 63 of the transmitter unit 6 to govern generation of oscillation frequencies.

The operable part 711 of the frequency channel switch 71 is disposed at the outside surface of the housing 31, and is accessible by a user to change transmission frequency channels. After the frequency channel switch 71 receives a frequency selection instruction from the user, the microcontroller 72 controls the phase lock unit 73. The phase lock unit 73 transmits the control voltage for precise control of the voltage-controlled oscillator's 63 output clock or signal frequency.

In use, the voice of the user or another audio signal is received by the limiting unit 4 through the aforementioned microphone 1. When the amplitude of the input audio signal falls within the predetermined scope and does not exceed the input threshold value, the feedback circuit 42 does not vary the resistance of the variable resistance unit 411. The audio signal is then communicated to the amplifying unit 5 and the transmitter unit 6 for subsequent wireless transmission to the signal receiving device 2 for output through the speakers 21.

The sound output from the speakers 21 may be picked up by the microphone 1 and received by the limiting unit 4 to be output to the amplifying unit 5 for amplification. If the amplitude of the audio signal output from the microphone 1 exceeds the input threshold value, this indicates that the volume of the input audio signal is outside an acceptable limit. As the amplitude of the audio signal output from the primary circuit 41 increases, the voltage output from the rectification filter 421 of the feedback circuit 42 is also increased. If the DC voltage output of the rectification filter 421 exceeds the DC voltage threshold value, the follower unit 422 begins to output a voltage that follows the DC voltage output of the rectification filter 421. This modulates the resistance of the variable resistance unit 411 to reduce the gain of the primary circuit 41. Thus, howling, background echo, or other undesirable sounds caused by recurring entry of the excessively large amplitude audio signal into the amplifying unit 5 are avoided. In this way, preferred operation is maintained during use of the personal transmitter, such as during a performance or speech.

In sum, in the present invention, when the amplitude of the audio signal input from the microphone 1 exceeds the input threshold value, the voltage output from the rectification filter 421 of the feedback circuit 42 is increased past a DC voltage threshold value. This causes the follower unit 422 to start modulating the resistance of the variable resistance unit 411 to reduce the gain of the primary circuit 41. This avoids generation of howling, background echo, or other undesirable noises in the speakers 21 from repeated amplification of the excessively large audio signal through the personal transmitter.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. A personal transmitter for receiving and wirelessly transmitting an audio signal of a microphone, said personal transmitter comprising:
a case;
a limiting unit disposed in said case and including
a primary circuit for receiving the audio signal of the microphone and adjusting an amplitude of the audio signal, said primary circuit having a variable resistance unit and a forward amplifier coupled together, and
a feedback circuit coupled to said primary circuit for receiving an output of said primary circuit and for feedback control that reduces a gain of said primary circuit when the amplitude of the audio signal exceeds a predetermined input threshold value;
an amplifying unit disposed in said case and coupled to said limiting unit for receiving and amplifying an output of said limiting unit; and
a transmitter unit disposed in said case and coupled to said amplifying unit for receiving and wirelessly transmitting an output of said amplifying unit.

2. The personal transmitter as claimed in claim 1, wherein said feedback circuit lowers a resistance of said variable resistance unit to thereby reduce the gain of said primary circuit when the amplitude of the audio signal exceeds the input threshold value.

3. The personal transmitter as claimed in claim 1, wherein said feedback circuit has a feedback amplifier, a rectification filter, and a follower unit, coupled together in series.

4. The personal transmitter as claimed in claim 3, wherein said feedback amplifier receives and amplifies the output of said primary circuit, said rectification filter receives an output of said feedback amplifier and generates a direct current voltage therefrom, and said follower unit receives the direct current voltage from said rectification filter and adjusts said variable resistance unit when the direct current voltage exceeds a predetermined DC voltage threshold value to thereby reduce the gain of said primary circuit.

5. The personal transmitter as claimed in claim 4, wherein said follower unit outputs a control voltage that is maintained at a constant value when the direct current voltage from said rectification filter is at or below the predetermined DC voltage threshold value, thereby maintaining a resistance value of said variable resistance unit, the control voltage being varied when the direct current voltage from said rectification filter exceeds the predetermined DC voltage threshold value, thereby adjusting the resistance value of said variable resistance unit to reduce the gain of said primary circuit.

6. The personal transmitter as claimed in claim 5, wherein said variable resistance unit includes a first resistor and a second resistor connected in series in a voltage divider configuration having an input voltage and an output voltage, in which the input voltage is applied to the first and second resistors and is the audio signal of the microphone, and the output voltage is a voltage drop across said second resistor and is supplied to said forward amplifier, said second resistor being a variable resistor with a variable resistance, the control voltage of said follower unit when constant acting on said second resistor such that the variable resistance thereof is constant, the control voltage of said follower unit when varied acting on said second resistor such that the variable resistance thereof is lowered to thereby lower the output voltage of said variable resistance unit.

7. The personal transmitter as claimed in claim 6, wherein the output voltage of said follower unit is substantially zero volts when the direct current voltage from said rectification filter is at or below the DC voltage threshold value, and the output voltage of said follower unit is a non-zero value that is varied according to the direct current voltage from said rectification filter when the direct current voltage from said rectification filter exceeds the DC voltage threshold value.

8. The personal transmitter as claimed in claim 1, wherein said amplifying unit includes a preamplifier, a high frequency amplifier, and a compressor coupled together in series.

9. The personal transmitter as claimed in claim 1, wherein said transmitter unit includes
a carrier frequency oscillator for generating a carrier wave,
a modulator coupled to said carrier frequency oscillator and said amplifying unit for receiving and incorporating the output of said amplifying unit into said carrier wave,
a voltage-controlled oscillator coupled to said modulator for receiving and modifying an output of said modulator,
a radio frequency amplifier coupled to said voltage-controlled oscillator for amplifying an output of said voltage-controlled oscillator, and
an antenna coupled to said radio frequency amplifier and disposed outside of said housing for wirelessly transmitting an output of said radio frequency amplifier.

10. The personal transmitter as claimed in claim 9, further comprising
a frequency switching unit that includes
a frequency channel switch having an operable part disposed outside of said case to thereby enable manipulation by a user,
a microcontroller coupled to said frequency channel switch for identifying an operating state of said frequency channel switch, and
a phase lock unit coupled to and controlled by said microcontroller for transmitting a voltage to govern generation of oscillation frequencies of said voltage-controlled oscillator of said transmitter unit.

11. The personal transmitter as claimed in claim 1, further comprising a clip disposed on a side of said case.
